(19) United States
(12) Patent Application Publication
(10) Pub. No.: US 2015/0186830 A1
(43) Pub. Date: Jul. 2, 2015

(54) SERVICE TRACKING ANALYTICS

(71) Applicant: Bank of America Corporation, Charlotte, NC (US)

(72) Inventor: Soren Dossing, Tokyo (JP)

(73) Assignee: Bank of America Corporation, Charlotte, NC (US)

(21) Appl. No.: 14/145,977

(22) Filed: Jan. 1, 2014

(51) Int. Cl. G06Q 10/06

(52) U.S. Cl. CPC G06Q 10/063114; G06Q 10/063118

(57) ABSTRACT

Embodiments for tracking and analyzing services include systems for receiving a service request that includes one or more tasks and creating a routing rule for each task. Further, the embodiments include identifying a task owner for each task based on the routing rule. The task owner establishes an operational level agreement that is received by the systems, where the operational level agreement includes an estimated time period needed to complete the one or more tasks. Upon completion of the tasks, records are received task data is extracted and analyzed to produce calculation, comparisons, and summaries for high level and low level reports.

### BACKGROUND

In many business sectors, such as information technology, services requests involving a wide array of technologies and processes are common. Fulfilling such service requests in a timely fashion can be challenging due to resource constraints, complicated flow paths, personnel issues, and so forth. Indeed, many support personnel tasked with completing service requests are unaware of the effect their performance has on the fulfillment of the service request. Without this knowledge, fulfillment process optimization can be difficult to achieve.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

The embodiments provided herein are directed to systems for tracking and analyzing services. In some embodiments of the systems, the systems include computer apparatus including a processor and a memory; and a service tracking software module stored in the memory, comprising executable instructions that when executed by the processor cause the processor to: receive a service request comprising one or more tasks. In some embodiments, the executable instructions further cause the processer to create a routing rule for each task. In some embodiments, the executable instruction further cause the processer to identify a task owner for each task based on the routing rule. In some embodiments, the executable instructions further cause the processer to receive an operational level agreement (OLA) from the task owner for each task, where the OLA comprises the estimated time period needed to complete the one or more tasks. In some embodiments, the executable instructions further cause the processer to receive records of the one or more tasks upon completion of the tasks and extract task information from the records. In some embodiments, the executable instructions further cause the processer to analyze the task information and OLA. In some embodiments, the executable instructions further cause the processer to provide a record comprising varying aggregated levels of analysis to a user.

In additional embodiments of the systems, the executable instructions further cause the processor to identify one or more fulfillers of the one or more tasks and determine whether the one or more fulfillers and the task owner of each task match. In other embodiments, the executable instructions further cause the processor to aggregate the one or more fulfillers and task owner of each task; calculate the number of tasks completed by a first fulfiller matched to the task owner; and calculate the number of tasks completed by a second fulfiller not matched to the task owner. In still other embodiments, the executable instructions further cause the processor to provide a report to the task owner comprising the number of tasks assigned and completed by the task owner, the number of tasks not assigned and completed by the task owner, and the number of tasks assigned and completed by another. In some embodiments, the executable instructions further cause the processor to determine the duration of each of the one or more tasks; compare the duration of each task and the OLA of each task; and determine whether the task was completed within the OLA or beyond the OLA.

In further embodiments of the systems, the executable instructions further cause the processor to determine that the duration of at least one task is less than the estimated time period of the OLA associated with the at least one task and greater than a predefined threshold and determine that the at least one task is not compliant with the OLA based on the determination. In still further embodiments, the executable instructions further cause the processor to calculate an adoption ratio as the number of tasks assigned to the task owner and completed by the task owner versus the total number of tasks assigned to the task owner and determine potential gains from improving adoption of the routing rules by the task owner based on the adoption ratio. In other embodiments, the executable instructions further cause the processor to calculate the number of days it takes to complete a task starting on the day the task is assigned to the day the task is closed and determine efficiency of the task owner in completing the one or more tasks, the efficiency being adversely correlated to the calculated number of days.

In some embodiments, the task information comprises routing data, fulfillment data, organizational data, and duration data In additional embodiments, the executable instructions further cause the processor to divide the at least one task into multiple portions and assign each portion of the at least one task to one or more task owners. In further embodiments, the executable instructions further cause the processor to assign a workflow to the one or more tasks, where a first set of tasks is configured to occur in chronological order and a second set of tasks is configured to occur in parallel based on the workflow.

Also provided herein, are embodiments directed to a computer program product for tracking and analyzing services. In some embodiments, the computer program product includes a non-transitory computer readable storage medium having computer readable program code embodied therewith, the computer readable program code comprising computer readable program code configured to receive a service request comprising one or more tasks.

In some embodiments, the computer readable program code includes computer readable program code configured to create a routing rule for each task. In some embodiments, the computer readable program code includes computer readable program code configured to identify a task owner for each task based on the routing rule. In some embodiments, the computer readable program code includes computer readable program code configured to receive an operational level agreement (OLA) from the task owner for each task, wherein the OLA comprises the estimated time period needed to complete the one or more tasks. In some embodiments, the computer readable program code includes computer readable program code configured to receive records of the one or more tasks upon completion of the tasks and extract task information from the records. In some embodiments, the computer readable program code includes computer readable program code configured to analyze the task information and OLA. In some embodiments, the computer readable program code includes computer readable program code configured to provide a record comprising varying aggregated levels of analysis to a user.

In other embodiments, the computer readable program code further includes comprising computer readable program code configured to identify one or more fulfillers of the one or more tasks and determine whether the one or more fulfillers and the task owner of each task match. In still other embodiments, the computer readable program code further includes computer readable program code configured to aggregate the one or more fulfillers and task owner of each task; calculate the number of tasks completed by a first fulfiller matched to the task owner; and calculate the number of tasks completed by a second fulfiller not matched to the task owner. In further embodiments, the computer readable program code further includes computer readable program code configured to calculate an adoption ratio as the number of tasks assigned to the task owner and completed by the task owner versus the total number of tasks assigned to the task owner and determine potential gains from improving adoption of the routing rules by the task owner based on the adoption ratio. In additional embodiments, the computer readable program code further includes computer readable program code configured to calculate the number of days it takes to complete a task starting on the day the task is assigned to the day the task is closed and determine efficiency of the task owner in completing the one or more tasks, the efficiency being adversely correlated to the calculated number of days.

Further provided herein are embodiments directed to computer-implemented methods for tracking and analyzing services. In some embodiments, the methods include receiving a service request comprising one or more tasks. In some embodiments, the methods include creating, by a processor, a routing rule for each task. In some embodiments, the methods include identifying, by a processor, a task owner for each task based on the routing rule. In some embodiments, the methods include receiving an operational level agreement (OLA) from the task owner for each task, wherein the OLA comprises the estimated time period needed to complete the one or more tasks. In some embodiments, the methods include receiving records of the one or more tasks upon completion of the tasks and extract task information from the records. In some embodiments, the methods include analyzing, by a processor, the task information and OLA. In some embodiments, the methods include providing, by a processor, a record comprising varying aggregated levels of analysis to a user.

In further embodiments, the methods further include determining, by a processor, the duration of each of the one or more tasks; comparing, by a processor, the duration of each task and the OLA of each task; and determining, by a processor, whether the task was completed within the OLA or beyond the OLA. In still further embodiments, the methods further include calculating, by a processor, an adoption ratio as the number of tasks assigned to the task owner and completed by the task owner versus the total number of tasks assigned to the task owner and determining, by a processor, potential gains from improving adoption of the routing rules by the task owner based on the adoption ratio. In additional embodiments, the methods further include calculating, by a processor, the number of days it takes to complete a task starting on the day the task is assigned to the day the task is closed and determining, by a processor, efficiency of the task owner in completing the one or more tasks, the efficiency being adversely correlated to the calculated number of days.

Other aspects and features, as recited by the claims, will become apparent to those skilled in the art upon review of the following non-limited detailed description of the invention in conjunction with the accompanying figures.

### BRIEF DESCRIPTION OF THE SEVERAL VIEWS OF THE DRAWINGS

The present embodiments are further described in the detailed description which follows in reference to the noted plurality of drawings by way of non-limiting examples of the present embodiments in which like reference numerals represent similar parts throughout the several views of the drawings and wherein:

FIG. 1 provides a block diagram illustrating a system and environment for tracking and analyzing service request in accordance with the embodiments presented herein;

FIG. 2 provides a block diagram illustrating the service management system, the third party system, and the user capture device of FIG. 1, in accordance with various embodiments;

FIG. 3 is a flowchart illustrating a system and method for tracking and analyzing service requests in accordance with various embodiments;

FIG. 4 is a flowchart illustrating a system and method for tracking and analyzing service requests in accordance with various embodiments;

FIG. 5 illustrates exemplary service requests and routing rules in accordance with various embodiments;

FIG. 6 illustrates an efficiency graph in accordance with various embodiments;

FIG. 7 illustrates an exemplary GUI of a service analytical record in accordance with various embodiments;

FIG. 8 illustrates an exemplary GUI of a service analytical record in accordance with various embodiments;

FIG. 9 illustrates an exemplary GUI of a service analytical record in accordance with various embodiments;

FIG. 10 illustrates an exemplary GUI of a service analytical record in accordance with various embodiments;

FIG. 11 illustrates an exemplary GUI of a service analytical record in accordance with various embodiments;

FIG. 12 illustrates an exemplary GUI of a service analytical record in accordance with various embodiments;

FIG. 13 illustrates an exemplary GUI of a service analytical record in accordance with various embodiments;

FIG. 14 illustrates an exemplary GUI of a service analytical record in accordance with various embodiments;

FIG. 15 illustrates an exemplary GUI of a service analytical record in accordance with various embodiments;

FIG. 16 illustrates an exemplary GUI of a service analytical record in accordance with various embodiments; and

FIG. 17 illustrates an exemplary GUI of a regional working site grid in accordance with various embodiments.

### DETAILED DESCRIPTION

The embodiments presented herein are directed to systems, methods, and computer program products for tracking and analyzing service requests and providing performance reports with varying levels of data. The embodiments create routing rules for service requests and identify task owners. The routing rules and tasks are provided to the task owners, and once the tasks are completed, data related to completed tasks is aggregated, processed, and analyzed. The analyzed data is summarized and reported to the task owners, service requesters, operators, management, and others. In this way, task owners and other interested parties can drill up or down in interactive reports to obtain details of performance in processing tasks and service requests at a high level or at a very detailed level. By providing data analytics to entities involved in the service request process, a better understanding of the challenges and strengths of each region, team, manager, or assignee can be obtained. In this way, all parties responsible for fulfilling service requests can use the data to optimize tools and processes to improve future performance.

The embodiments of the disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present embodiments of the disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present embodiments of the disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present embodiments of the disclosure are described below with reference to flowchart illustrations and/or block diagrams of methods, apparatus (systems) and computer program products according to embodiments of the embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

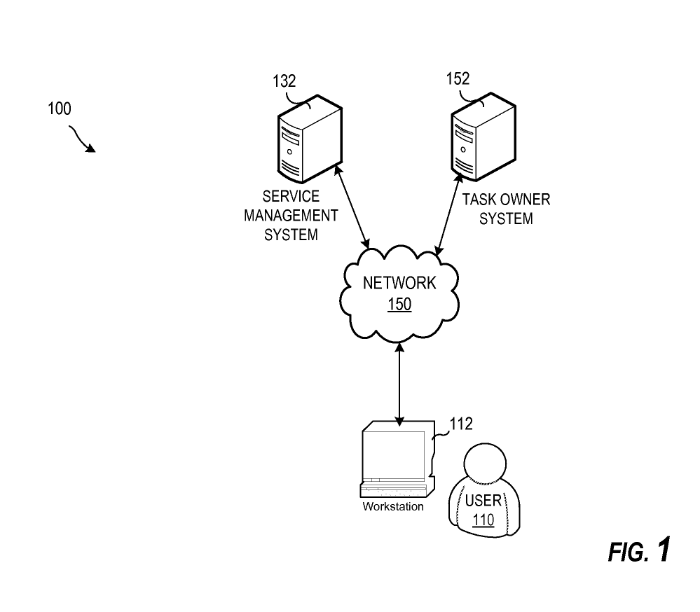

Referring now to the figures, FIG. 1 provides a block diagram illustrating a system and environment 100 for analyzing service requests. The system 100 includes a user 110, a device 112 of the user 110, a service management system 132, and a task owner system 152, which are in communication with each other via a network 150. In some embodiments, a user includes an individual or entity associated with a financial system, an individual submitting a service request, a manager, an operator, a support team member, an assignee, a task owner, and the like. In some embodiments, the user 110 sends a service request to the service management system 132 via the network 150. The service management system 132 then processes the service request and assigns tasks to targeted groups. The service management system 132, in some exemplary embodiments, sends the tasks to the task owner system 152.

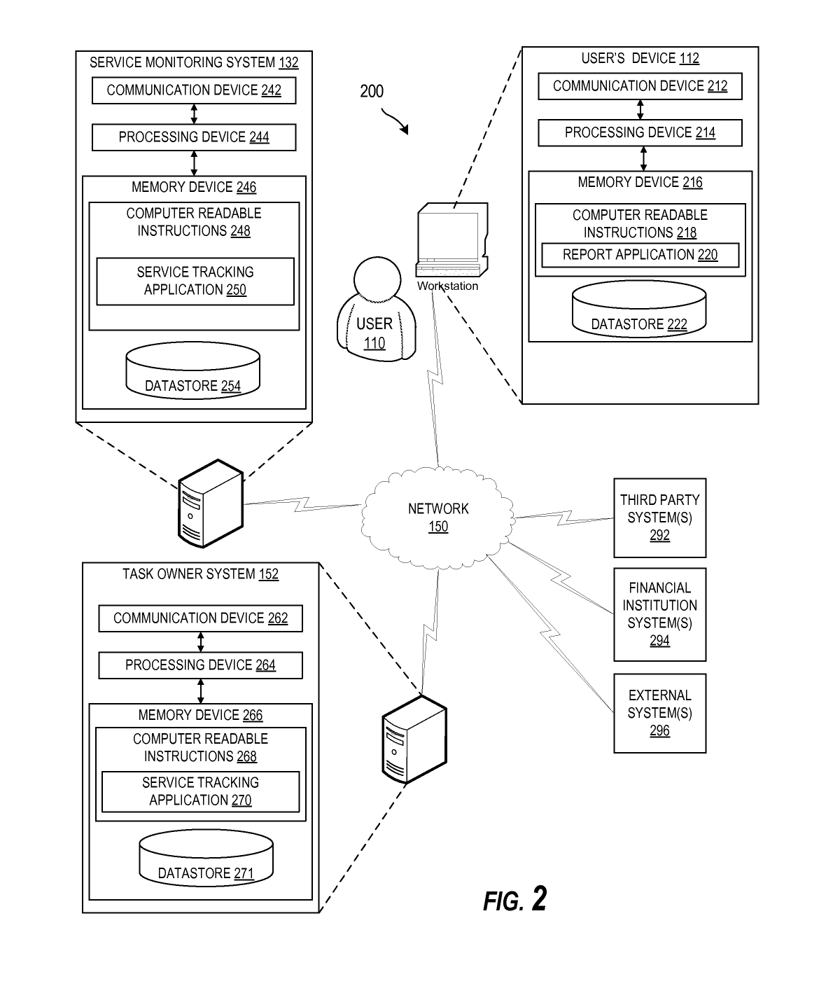

Referring now to FIG. 2, a block diagram illustrates an environment 200 for assessing service delivery. The environment 200 includes the user's device 112, the task owner system 152, and the service management system 132 of FIG. 1. The environment 200 further includes one or more third party systems 292 (e.g., a partner, agent, or contractor associated with the service management system provider and/or a service management), one or more service management systems 294 (e.g., a credit bureau, third party banks, and so forth), and one or more external systems 296. The systems and devices communicate with one another over the network 150 and perform one or more of the various steps and/or methods according to embodiments of the disclosure discussed herein. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet.

The user's device 112, the task owner system 152, and the service management system 132 each includes a computer system, server, multiple computer systems and/or servers or the like. The service management system 132, in the embodiments shown has a communication device 242 communicably coupled with a processing device 244, which is also communicably coupled with a memory device 246. The processing device 244 is configured to control the communication device 242 such that the service management system 132 communicates across the network 150 with one or more other systems. The processing device 244 is also configured to access the memory device 246 in order to read the computer readable instructions 248, which in some embodiments includes a service tracking application 250. The memory device 246 also includes a datastore 254 or database for storing pieces of data that can be accessed by the processing device 244. An exemplary mapping code that may be stored in the memory device 246 is provided herein.

As used herein, a “processing device,” generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 214, 244, or 264 may further include functionality to operate one or more software programs based on computer-executable program code thereof, which may be stored in a memory. As the phrase is used herein, a processing device 214, 244, or 264 may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “memory device” generally refers to a device or combination of devices that store one or more forms of computer-readable media and/or computer-executable program code/instructions. Computer-readable media is defined in greater detail below. For example, in one embodiment, the memory device 246 includes any computer memory that provides an actual or virtual space to temporarily or permanently store data and/or commands provided to the processing device 244 when it carries out its functions described herein.

The user's device 112 includes a communication device 212 and communicably coupled with a processing device 214, which is also communicably coupled with a memory device 216. The processing device 214 is configured to control the communication device 212 such that the user's device 112 communicates across the network 150 with one or more other systems. The processing device 214 is also configured to access the memory device 216 in order to read the computer readable instructions 218, which in some embodiments includes a report application 220. The memory device 216 also includes a datastore 222 or database for storing pieces of data that can be accessed by the processing device 214.

The task owner system 152 includes a communication device 262 communicably coupled with a processing device 264, which is also communicably coupled with a memory device 266. The processing device 264 is configured to control the communication device 262 such that the task owner system 152 communicates across the network 150 with one or more other systems. The processing device 264 is also configured to access the memory device 266 in order to read the computer readable instructions 268, which in some embodiments include a service tracking application 270 and a report application (not shown). The memory device 266 also includes a datastore 271 or database for storing pieces of data that can be accessed by the processing device 264.

In some embodiments, the report application 220 and the service tracking application 270 interact with the service tracking application 250 to receive or provide service requests, process the service requests, analyze and assign tasks, calculate task data, and provide varying levels of summaries and reports to task owners and users.

The applications 220, 250, and 270 are for instructing the processing devices 214, 244 and 264 to perform various steps of the methods discussed herein, and/or other steps and/or similar steps. In various embodiments, one or more of the applications 220, 250, and 270 are included in the computer readable instructions stored in a memory device of one or more systems or devices other than the systems 152 and 132 and the user's capture device 112. For example, in some embodiments, the application 220 is stored and configured for being accessed by a processing device of one or more third party systems 292 connected to the network 150. In various embodiments, the applications 220, 250, and 270 stored and executed by different systems/devices are different. In some embodiments, the applications 220, 250, and 270 stored and executed by different systems may be similar and may be configured to communicate with one another, and in some embodiments, the applications 220, 250, and 270 may be considered to be working together as a singular application despite being stored and executed on different systems.

In various embodiments, one of the systems discussed above, such as the service management system 132, is more than one system and the various components of the system are not collocated, and in various embodiments, there are multiple components performing the functions indicated herein as a single device. For example, in one embodiment, multiple processing devices perform the functions of the processing device 244 of the service management system 132 described herein. In various embodiments, the service management system 132 includes one or more of the external systems 296 and/or any other system or component used in conjunction with or to perform any of the method steps discussed herein. For example, the service management system 132 may include a financial institution system, an information technology system, and the like.

In various embodiments, the service management system 132, the task owner system 152, and the user's device 112 and/or other systems may perform all or part of a one or more method steps discussed above and/or other method steps in association with the method steps discussed above. Furthermore, some or all the systems/devices discussed here, in association with other systems or without association with other systems, in association with steps being performed manually or without steps being performed manually, may perform one or more of the steps of method 300, the other methods discussed below, or other methods, processes or steps discussed herein or not discussed herein.

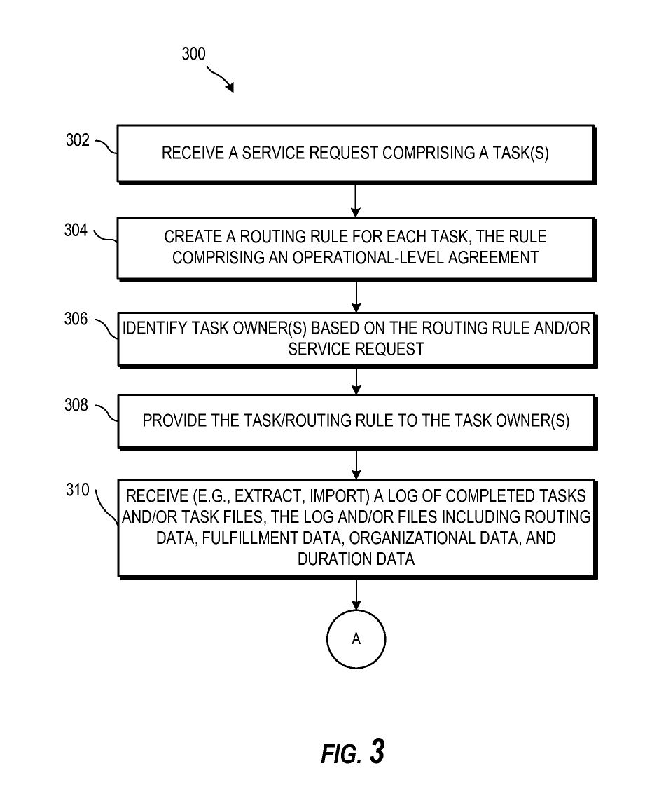

FIG. 3 illustrates a flowchart providing an overview of a process 300 for tracking and analyzing service delivery. One or more devices, such as the one or more capture devices and/or one or more other computing devices and/or servers of FIG. 1 and FIG. 2, can be configured to perform one or more steps of the process 300 described below. In some embodiments, the one or more devices performing the steps are associated with a service management provider. In other embodiments, the one or more devices performing the steps are associated with a merchant, business, partner, third party, credit agency, account holder, and/or user.

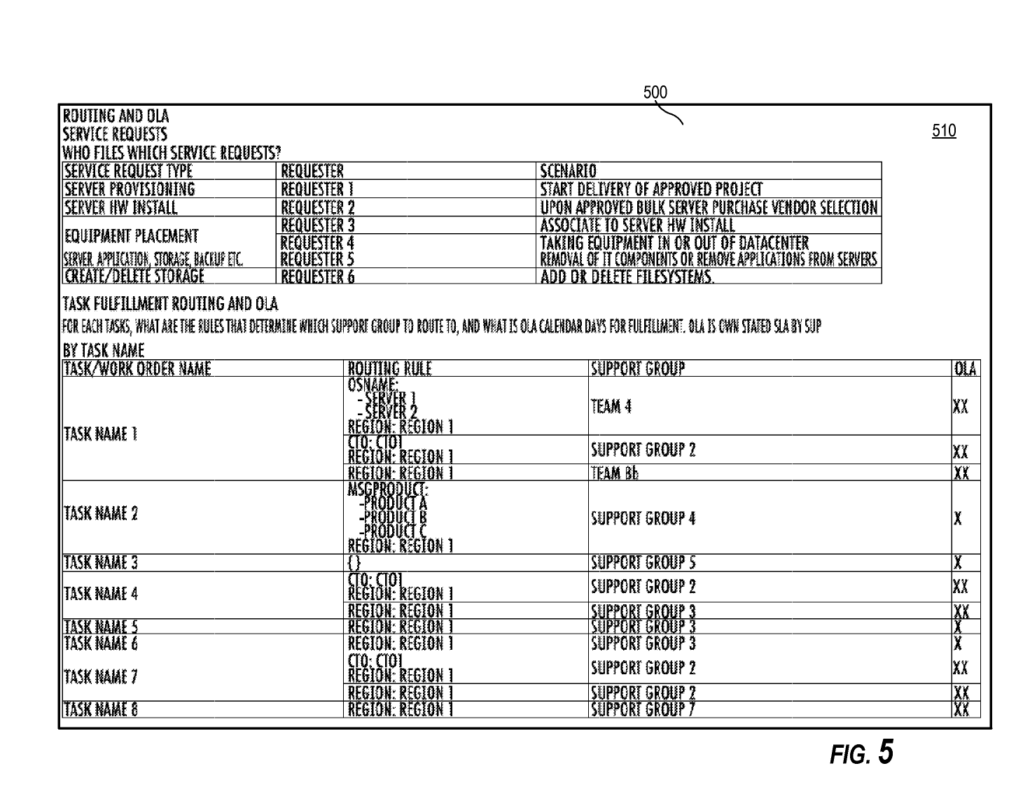

As illustrated at block 302, a service request comprising one or more tasks is received. In some embodiments, the service request comprises a service type, a requester, and a scenario, which describes the service. Exemplary service requests are illustrated in FIG. 5. The tasks are determined from the service request. Tasks include work assignments, process steps, outcomes, or any other job associated with completing the service request. Exemplary tasks include equipment repairs, wiring, installations, error detection, backups, purchases, business reviews, technology reviews, operating system configurations, upgrading software, and other information technology related tasks. Although the service requests and tasks described herein relate to information technology, it will be understood that the process 300 may be applied to any type of service request.

In some embodiments, the service requests are generated by various service request management systems that are in communication with the system of process 300. Different service request types in different service request management systems have different naming of data elements. The system of process 300 normalizes the data element names to enable analysis of teams and tasks regardless of the service request type or backend service request management system that generated the request. Exemplary code for normalization of the service request naming data elements is provided herein.

As illustrated at block 304, a routing rule is created for each of the one or more tasks. In some embodiments, the routing rule comprises an operational-level agreement (OLA). The operational-level agreement comprises the estimated time (e.g., number of days, hours, and so forth) needed to fulfill the tasks. The system of process 300 assigns a task name to each task and the work order of the tasks. Some of the tasks may be performed in a certain chronological order while other tasks may be done in parallel with other tasks when delivering the requested service. In a hardware repair request, for example, it may be first necessary to diagnose the identified malfunctioning hardware before parts are ordered, while a repair status reporting procedure may be done at any time. Further included in the routing rule are one or more operating system names needed to carry out at least a portion of the task, the region associated with the task, officers, databases, and/or products. A portion of an exemplary routing rule is illustrated in FIG. 5, which includes a GUI 500 of a web portal 510 providing service requests, routing rules, and OLAs.

As illustrated at block 306, at least one task owner is identified based on the routing rule and/or service request. For example, as shown in FIG. 5, the operating system name and the region given in the routing rule is used to determine that Team 4 is one of the task owners for a task having the name Task Name 1. In some embodiments, the task owner comprises at least one targeted support group, manager, team leader, individual, assignee, and the like. Each task may be assigned one task owner or multiple task owners. For example, multiple support groups may be each assigned a portion of a single task. Each assigned portion may be done in parallel or chronological order in order for the single task to be fulfilled. In cases where the task owner comprises a support group, each support group may comprise one or more assignees. Further, the task owner may submit the OLA estimating the time needed to complete at least a portion of the task. The OLA can be adjusted by the task owner if the submitted OLA is incorrect or as issues arise. For example, if the task owner's resources are not optimal for completing a task in a timely manner or if circumstances occur that impede the task owner's ability to complete a task, the task owner may re-submit the OLA.

As illustrated at block 308, the one or more tasks and/or the routing rule for each task is provided to the task owner. In some embodiments, the task owner or members of a task owner (e.g., assignees) may access a web portal to view the service request and determine the tasks assigned to them. In other embodiments, the task and/or routing rule may be sent the task owner via email, text, fax, hard copy, voice mail, or any other method.

As illustrated at block 310, a log of completed tasks and/or task files are received, where the log and/or tasks files includes task data. The task data comprising routing data, fulfillment data, organizational data, and duration data. In some embodiments, the data is extracted from the log and/or the task files. For example, the system of process 300 may receive an electronic document containing one or more portions of the routing data, fulfillment data, organizational data, and/or duration data, and identify and extract such data from the document.

The routing data includes routing rule data, regions, datacenters, operating system names, CTOs, products, categories, task names, and the like. The fulfillment data includes platforms, requested parties, requesters, task fulfillers, build-types, host names, tasks fulfilled, sequence of events, statuses, and the like. Organizational data includes task owners, management, support groups, assignees, and the like. The duration data includes request receipt times, task start times, task end times, duration calculations, duration predictions, and the like.

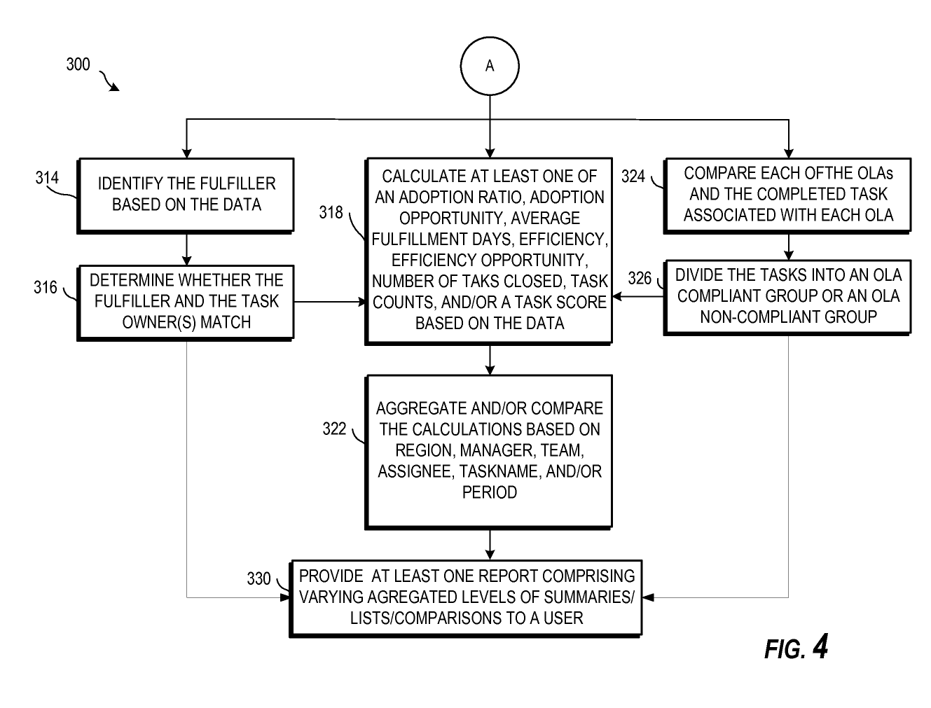

Referring now to FIG. 4, the process 300 is further illustrated. As illustrated at block 314, the fulfiller of the one or more tasks is identified based on at least a portion of the task data. The fulfiller may include one or more assignees, a support group, team leaders, managers, and the like. In some embodiments, the fulfiller is the entity that closes the task. For example, a user may access a service management web portal by submitting identification and passwords and close out a task in the web portal. The system of process 300 can identify the fulfiller based on the fulfiller's input.

As illustrated at block 316, a determination is made as to whether the fulfiller and the task owner match. In some cases, the task owner is not the assignee, support group, or team leader assigned to fulfill the task. Such a mismatch may waste resources, misappropriate resources, cause confusion, and the like. In other cases, the task owner and fulfiller match such that the most efficient task pathway is fulfilled. In still other cases, the system of process 300 determine that the task owner fulfills tasks not assigned the task owner, i.e., task assigned to others.

As illustrated at block 324, the OLAs and the completed task associated with each OLA are compared. For example, the duration or the start time and end time of the completed task are compared to the estimated time period of the OLA. As illustrated at block 326, the completed tasks are divided into an OLA compliant group and an OLA non-compliant group. In some cases, the OLA compliant group includes completed tasks that are fulfilled within or close to the time period established by the associated OLAs. In some cases, a “pad” may be assigned such that some tasks may be determined to be OLA compliant even though the duration of the task may extend beyond the OLA. For example, in cases where unexpected or uncontrollable circumstances occur (e.g., a weather related event, power outage, and the like), a few more days may be added to the OLA. In other cases, the completed tasks may only be deemed to be OLA compliant when it is some time period less than the OLA. Where the task includes more than one support group, when the request is urgent, or when the particular task is part of a chronological work flow, for example, the task may need to be completed within a time frame that is at least 80% of the OLA in order for the task to be OLA compliant. In still other cases, the completed task is OLA compliant when the task is less than or equal to the OLA.

In other embodiments, the OLA non-compliant group includes completed tasks that are not fulfilled within the time period established by the associated OLAs. For example, tasks that are completed in a time period that is greater than the maximum number of days defined by the OLA, the completed task is deemed to be OLA non-compliant. In other cases, the completed tasks may be OLA non-compliant event when the duration is equal to or less than the OLA.

As illustrated at block 318, at least one of an adoption ratio, adoption opportunity, average fulfillment days, efficiency, efficiency opportunity, number of tasks closed, task counts, and task score are calculated based on at least a portion of the task data, the fulfiller and task owner match, and/or OLA compliant group and non-compliant groupings.

The adoption ratio is calculated as the number of tasks belonging to the task owner and closed (i.e., fulfilled) by the task owner versus the total number of tasks belonging to the team. Tasks fulfilled for other teams have no effect on the adoption ratio.

Adoption Ratio=(# owned and closed)/(# owned and closed+# owned and missed)

The adoption opportunity relates to potential gains from improving adoption and is calculated as follows.

Adoption Opportunity=log10(1+−Adoption Ratio)*Task Count))

The task count is calculated as the number of tasks closed within a designated period. If no period is indicated, then the period is the latest three months.

The average fulfillment days is calculated as the average duration of one or more tasks closed in a time period, where the duration is calculated as the number of calendar days starting on the day the task is assigned to the day the task is closed. For example, if a task of installing a new program is fulfilled 122 times in a given month, the system determines the number of days from start to close it took to fulfill each of the 122 instances of the task, sums the total number of days, and divides by 122. The average fulfillment days may be based on all tasks or particular tasks assigned to a task owner during a certain period, all tasks or particular tasks completed in a region during a certain period, or all tasks or particular tasks completed globally during a time period.

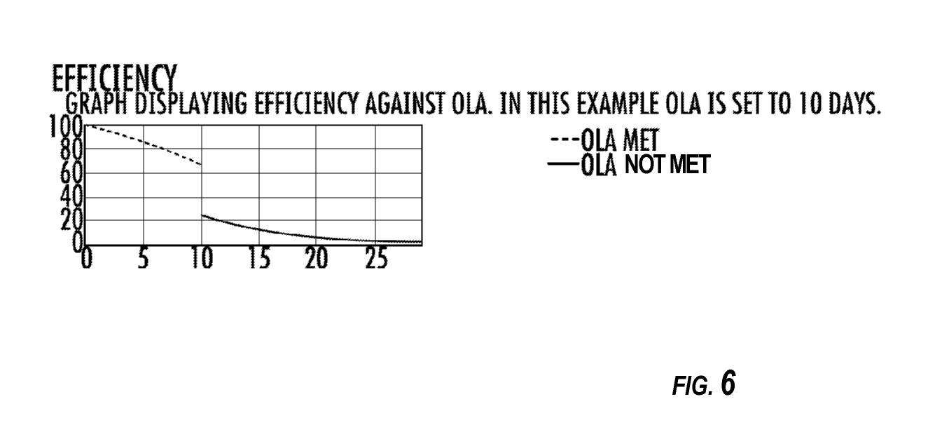

Efficiency compares actual fulfillment time to OLA for tasks assigned to the task owner. Immediate fulfillment=100% efficiency. As shown in FIG. 6, a graph of efficiency versus OLA is displayed. In the example, the OLA is set to 10 days. Just meeting the OLA (i.e., taking the full number of days allotted by the OLA)=50% efficiency. At 0-1 days, the efficiency is 100% and at 10 days, the efficiency is 50%. Tasks fulfilled beyond the OLA have a weight factor of 5. At day 15, 5 days after the OLA in the illustrated example, the efficiency is reduced to about 10% and reduced to about 5% at day 20, which is 10 days after the OLA.

Efficiency opportunity relates to potential gain from improving efficiency and is calculated as follows.

Efficiency Opportunity=log10(1+((1−Efficiency)*Task Count*Adoption ratio))

The task score is calculated as follows.

Task Score=log10(1+((Adoption Ratio+Efficiency)*(Task Count/(1+Avg. No. of Days)))

The average number of days is calculated as the average duration of a task closed in a period.

As illustrated at block 322, the adoption ratio, adoption opportunity, average fulfillment days, efficiency, efficiency opportunity, number of tasks closed, task counts, and task score, the fulfiller and task owner match, and/or OLA compliant groups and non-compliant groups are aggregated and/or compared based on at least one of a region, a manager, a team, an assignee, a task name, and a time period. Such comparisons can be used to gauge performance on global, regional, manager, team, or assignee level.

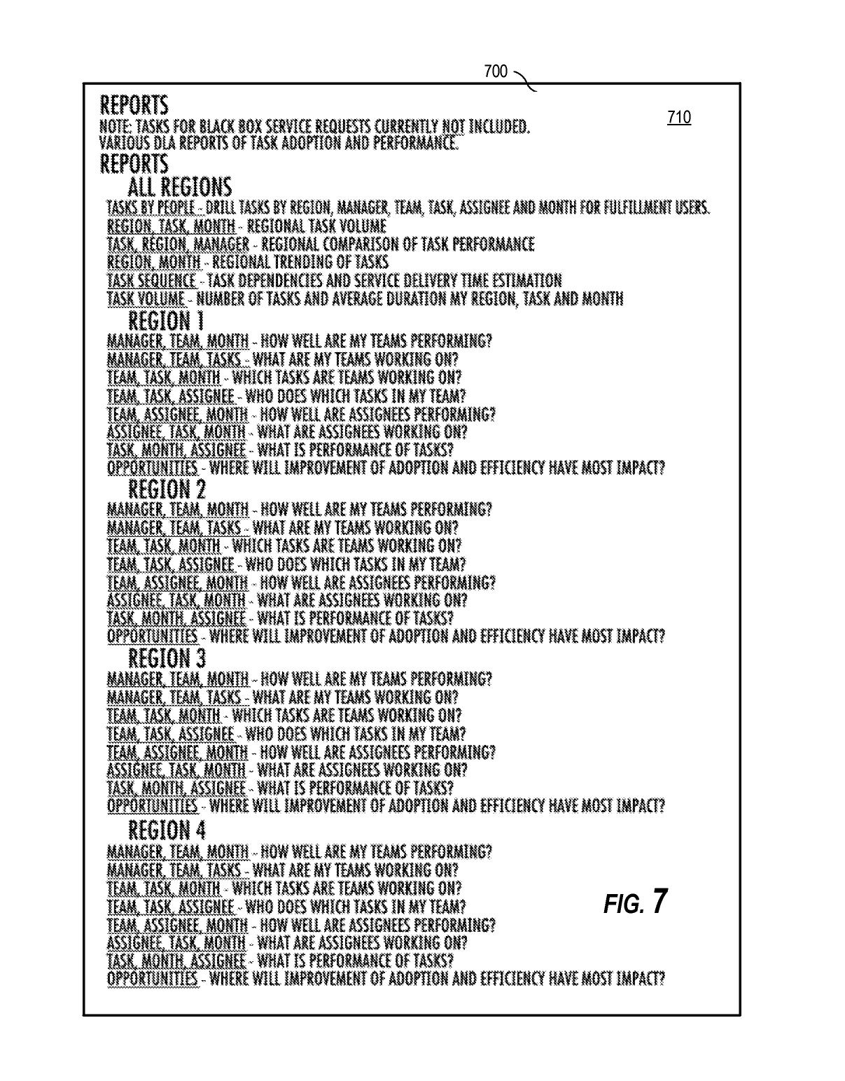

As illustrated at block 330, at least one report comprising varying aggregated levels of summaries, lists, and/or comparisons are provided to a user. Exemplary reports that include the summaries, lists, and comparisons are illustrated in FIGS. 7-16. In some embodiments, the reports are sent to an analysis group to determine the reasons for performance scores. By understanding and breaking down the performance data by team, task, region, and the like, managers, team members, analytic groups, and other users can determine the best course of action for improving performance.

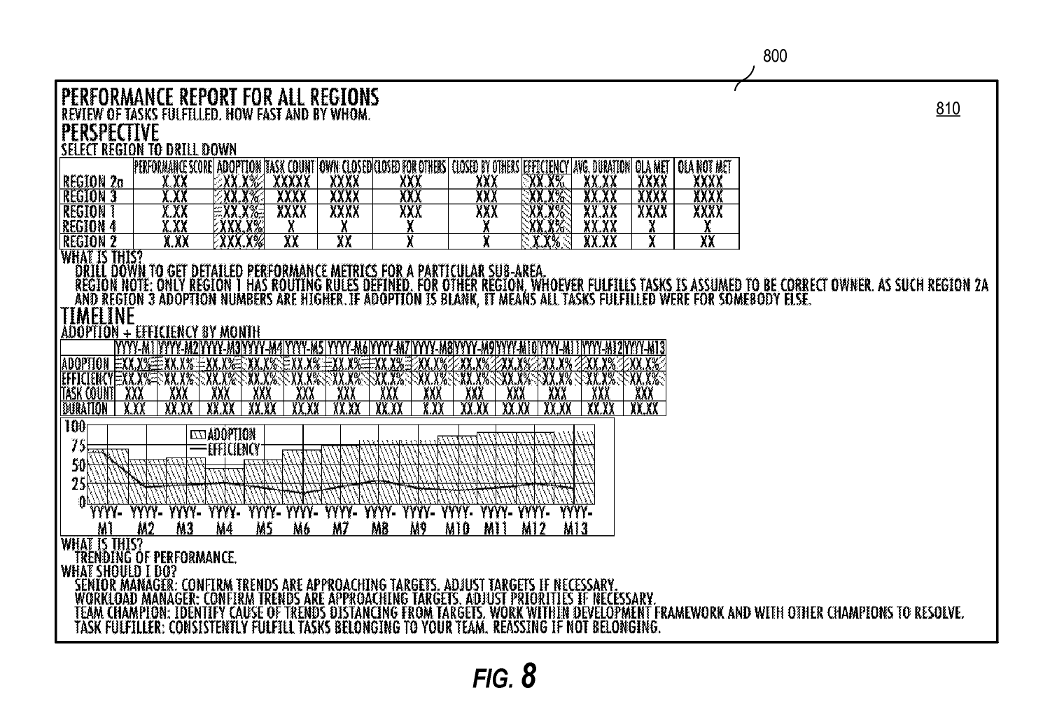

Referring now to FIG. 7, a graphical user interface (GUI) 700 of a reporting home page 710 is illustrated. The reporting home page 710 includes various links to reports for global and various regional aspects of the reporting process. The global reports available to users include tasks by people, regional task volume, regional trending of tasks, task dependencies, and service delivery time estimations, and task volumes. A global report is illustrated in FIG. 8 and described in further detail below.

Further illustrated in FIG. 7 are multiple regions (Regions 1-4) such as regions in Asia-Pacific, Canada, Europe, the Middle East, Australia, Africa, and Latin America. In each region, multiple regional reports broken down by manager, team, time period, task, assignee, opportunities, and combinations thereof.

Referring now to FIG. 8, a GUI 800 of a global performance report 810 is illustrated. The performance report 810 includes summaries of tasks fulfilled by various regions and a timeline section. In the perspective section, performance data for five regions are summarized. The regions are ranked based on the performance score from highest score to lowest score (e.g., the task score discussed above). In this example, Region 2a (a sub-region of Region 2) has the highest performance score and Region 2 has the lowest. The adoption ratio is high in Region 2a, Region 3, Region 4, and Region 2, the range of the adoption ratios in theses regions being 80-100%. As such, the boxes for those adoption ratios are highlighted in green. The adoption ratio in Region 1 is highlighted in a yellow color because it is associated with a 50-80% ratio. The efficiency scores for all of the regions are below 50% and are thus highlighted in red. It will be understood that such color coding may be implemented in all reports.

Further illustrated in the embodiment of FIG. 8, Region 2a has the highest task count. The number of tasks closed for others is not taken into account when calculating the adoption ratio. The perspective section also summarizes the number of tasks that have been met in the time period established in the OLA for each region, and the number of tasks that have been breached for not meeting the time period of the OLA.

In the timeline section of the GUI 800, global calculations, including the adoption ratio, efficiency, task count, and duration, are summarized for each month throughout a thirteen month period. Overall the adoption ratio has increased while the efficiency has decreased. Moreover, the number of tasks has also increased significantly over the thirteen month period. Underneath the adoption ratio/graph, instructions for evaluating the trends are provided.

The trends shown in GUI 800 may be due to any number of factors. In some cases, the reason for the drop in efficiency may be due to decreases in cross-team or duplicative efforts. For example, because more and more teams or task owners have increased adoption, such task owners have also become increasingly aware of which tasks are assigned to them and which tasks are assigned to others. As a result of the rise in adoption, more teams having the bandwidth to do tasks quickly may not be inclined to take on tasks not assigned to them. Further, some task owners may be in the habit of relying on other teams to fulfill tasks assigned to them and may not act promptly on some tasks. Possible solutions to this decrease in efficiency could be to urge managers and team champions to reassess their resources, tools, and processes, readjust the OLA, or reassign tasks. In other cases, the drop in efficiency may be due to the significant increases in task counts. In one exemplary embodiment of GUI 800, the task count went from about 200 tasks to over 9000 tasks over the thirteen month period. Such heavy increases in task counts could be taxing on all teams assigned to the tasks, which may have resulted in a drop in efficiency even as the adoption ratio increased during the period. In still other cases, the reasons for the trends may be related to transitional lag due to increases in adoption of the service tracking process and the routing rules, changes in personnel due to team members changing jobs or taking leave for holidays, newly hired team members with less experience, lags due to changes in technology, disruptions in operations due to natural disasters or other catastrophes, and the like.

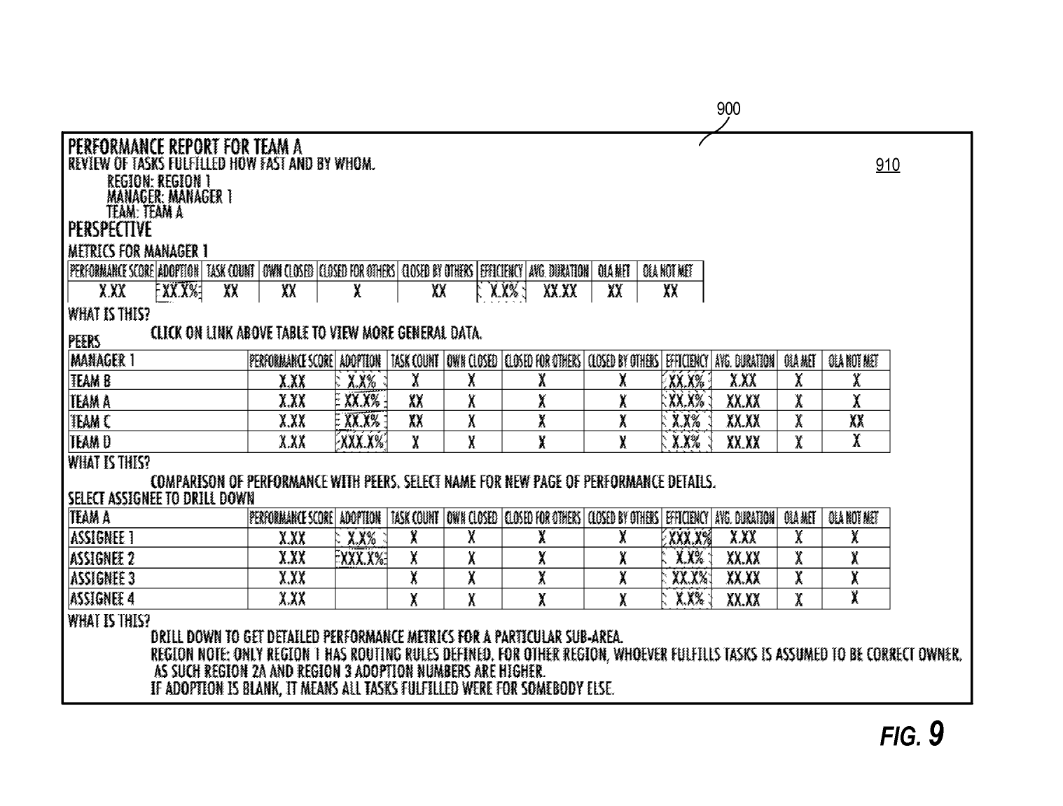

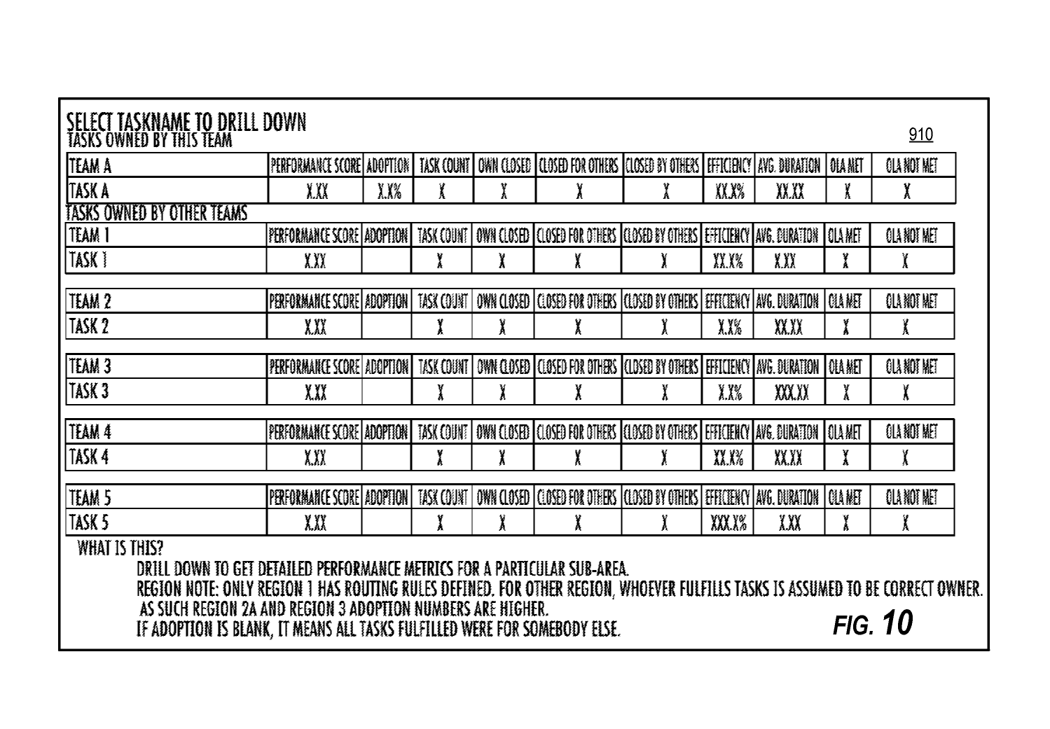

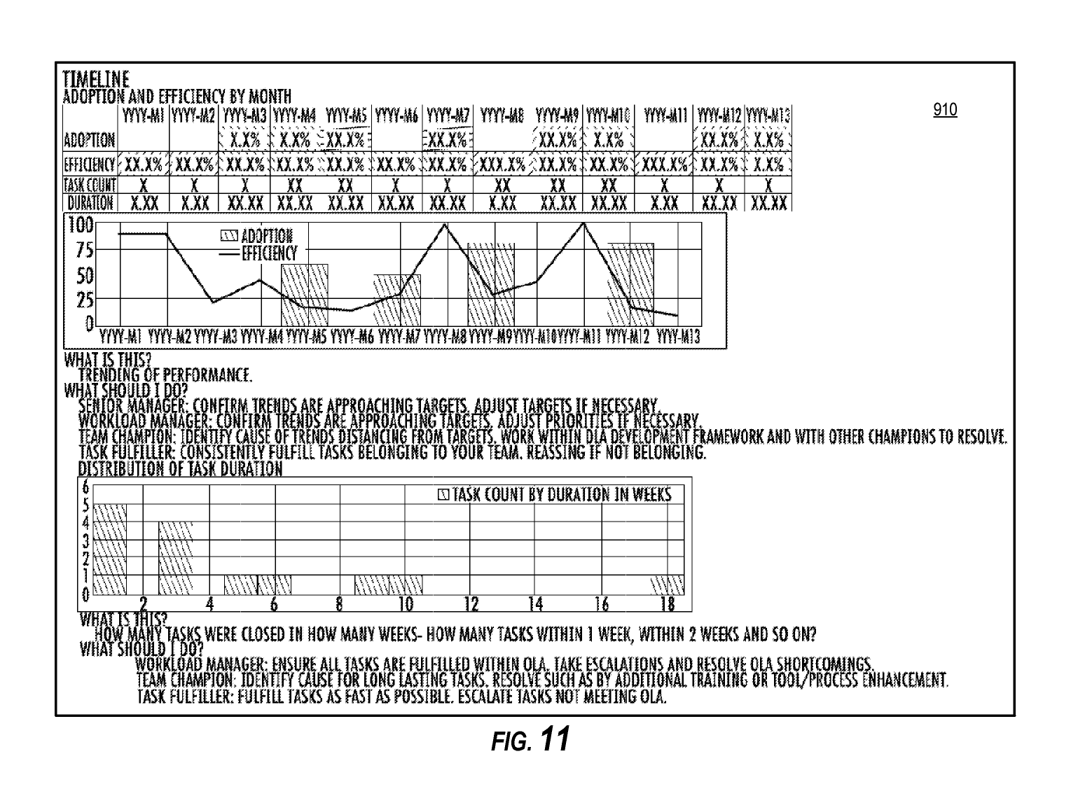

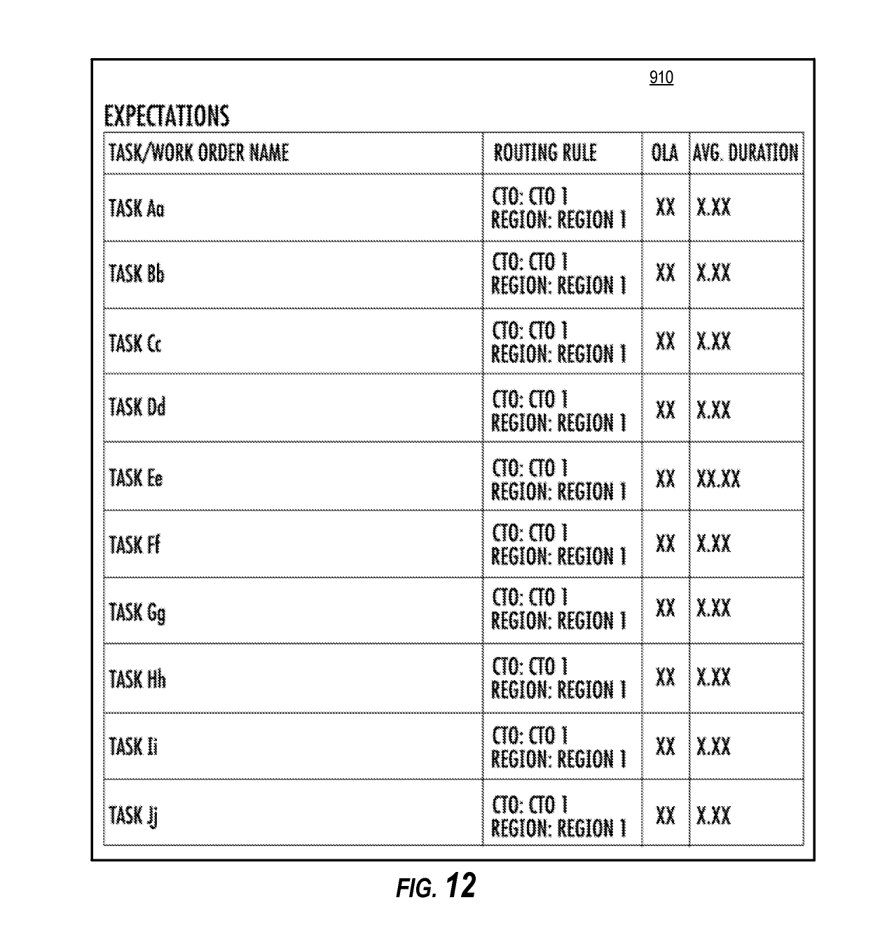

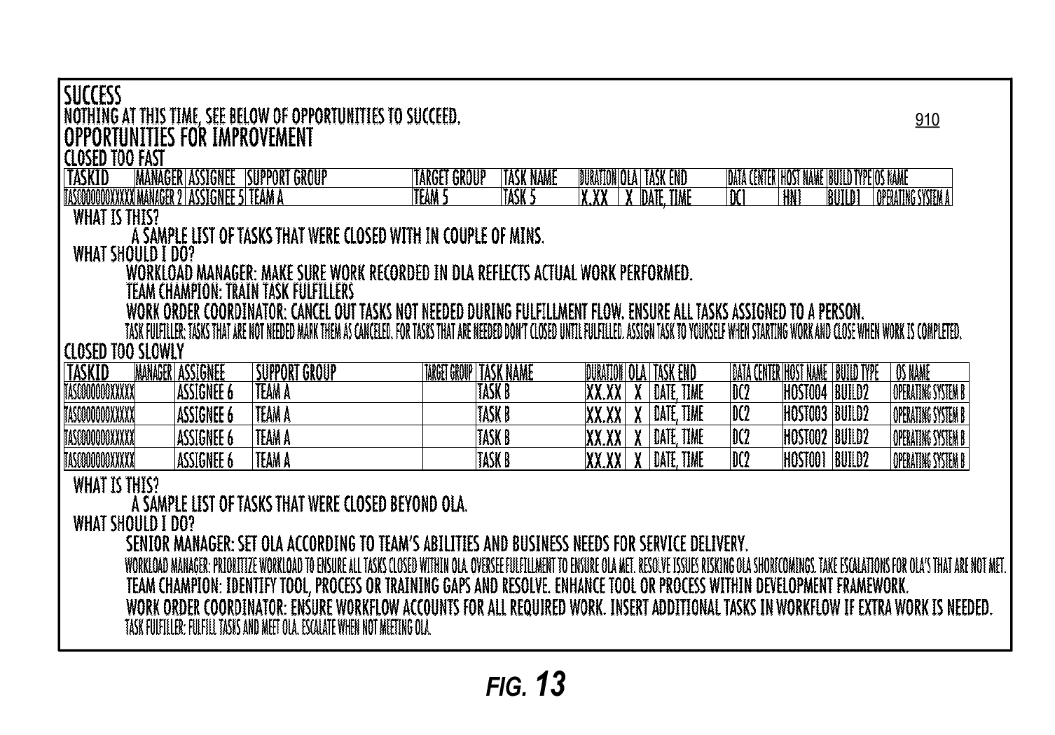

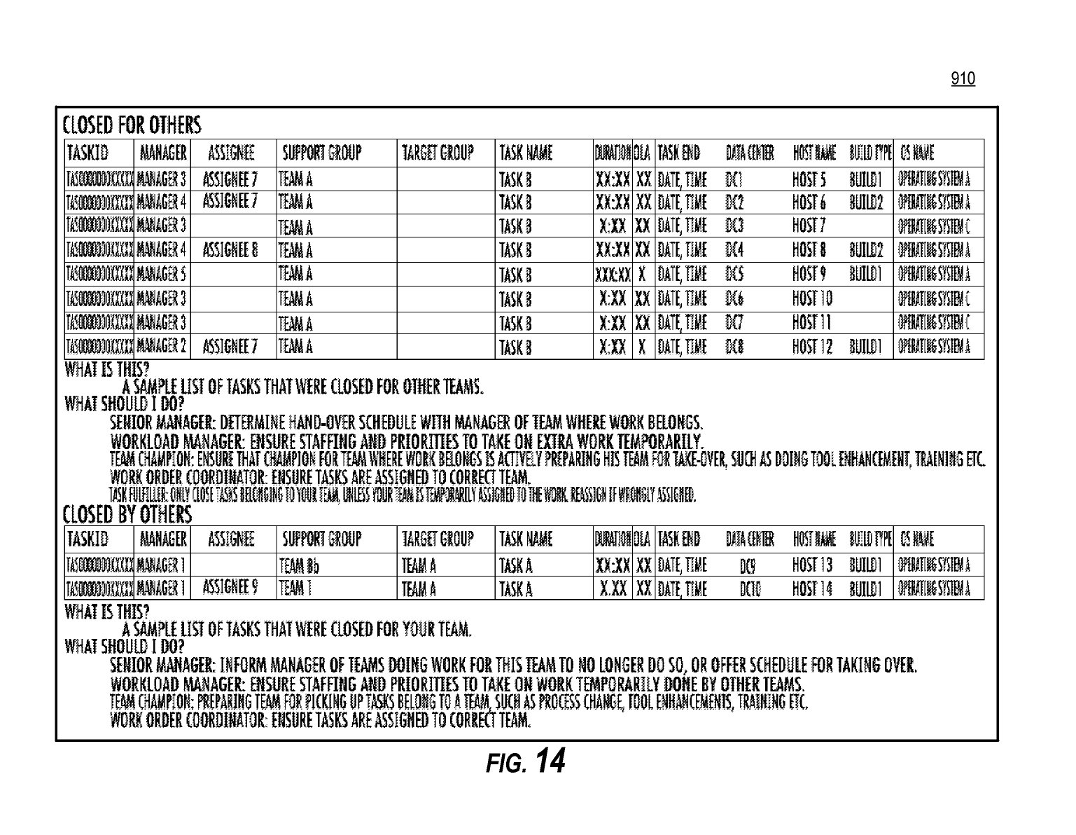

Referring now to FIG. 9, a GUI 900 illustrating a performance report 910 for a particular support group is provided. Listed near the top of the GUI 900 is the region where the support group is located, the manager of the support group, and the name of the team. Included in the report 910 are a perspective section, a task name section (see, FIG. 10), a timeline section (see, FIG. 11), an expectations section (see, FIG. 12), and a success section and an opportunities section (see, FIGS. 13-14).

As shown in FIG. 9, the perspective section includes metrics for the manager of the reporting support team, i.e. Manager 1, a peers team comparison table, and an assignees table. In the peers team comparison table, calculations for four support teams associated with Manager 1 are summarized. In this way, Manager 1's overall performance can be better analyzed. For example, if one particular team takes up more of a manger's time because that team has more tasks than other teams, then it may be expected that such a team would take away from the manager's performance in other teams. Also, some teams may be more important or have tighter deadlines than other teams. In the illustrated embodiment, Manager 1 is not closing tasks for Team B resulting in a very low adoption ratio (0.0%), but a high efficiency (90%) because other teams have fulfilled the tasks assigned for that team in a timely manner. On the other side of the scale, Team D has a high adoption ratio (100%) as every single one of the tasks that was owned by the team was also completed by the team. However, the efficiency ratio for Team D is quite low (<10%) because none of the OLA's were met. These extremes in calculations can be used to better analyze the subject team in the report 910, i.e., Team A. FIG. 9 also includes the assignees table, where each assignee is part of the subject team of the report 910.

The performance report 910 for the subject team is further illustrated in FIG. 10. The task name section includes the tasks owned by the targeted support team, i.e., the task owner of the tasks in the illustrated embodiment. Task A, owned by the targeted support team indicates that the tasks were not fulfilled by the targeted support team but by another team resulting in a 0.0% adoption ratio. Also included in the task name section, are columns of tasks owned by the targeted support team but fulfilled by other teams.

Referring now to FIG. 11, the timeline section of the performance report 910 for the subject team of FIG. 9 is provided. A table and graph related to adoption and efficiency over a period of time for the targeted support team is illustrated. For the months where the adoption ratio was recorded, the efficiency was under 50% (and highlighted in red). For the months where the adoption ratio was not calculated, the efficiency varies. For the months where the efficiency was above 80% (and highlighted in green), the adoption ratio was not recorded. The reason for this trend in efficiency could be that the other teams were promptly fulfilling those tasks.

Also shown in FIG. 11 is a task by duration graph. The y-axis indicates the number of weeks (0-6 weeks) and the x-axis indicates the number of tasks. As shown in the graph, the majority of the tasks are done under 1 week, while other tasks take as long as 5 weeks.

FIG. 12 illustrates the expectations section of the performance report 910 of FIG. 9. The expectations section lists the task names in chronological order, the routing rule, and the average duration of each task. In this example, only one task (Task Ee) was completed by the targeted team, which took over 30 days to complete. All other tasks were either not completed at the time the report was printed or were completed by other teams.

FIGS. 13-14 illustrate the success section and the opportunities section of the performance report 910. As illustrated, the success section had nothing to report. If the subject team had success, such as increased adoption and efficiency, such information would be provided in the success section. The opportunities section includes a “closed too fast” table, a “closed too slowly” table, a “closed for others” table, and a “closed by others” table. The closed too fast table includes a sample list of tasks that were closed within a couple of minutes after they were opened. As shown in FIG. 13, the table lists the task ID, the manager assigned to the task, the assignee, the support team fulfilling the task, the target team (i.e., the task owner), duration (e.g., 0.00 days), the OLA (e.g., 7 days), the time and date the task was closed, the data center associated with the task, the host name, the build type, and the operating system name. In some cases, some tasks may be closed almost immediately after they are sent to the task owner if the task is unnecessary, unassigned, out of place, or redundant in fulfilling the service request. In some embodiments, it is preferred that such tasks be cancelled or otherwise rectified rather than closed. This ensures that task duration is accurately recorded. In other cases, some tasks are closed too quickly before the task is actually completed. For example, a task fulfiller (e.g., an assignee or team member) may plan to fulfill the task later in the day or week, and may prematurely close the task. Closing tasks too quickly can result in inaccurate data.

Returning again to FIG. 13, the closed too slowly table lists a sample of tasks that were closed beyond the time specified in the OLA. In an exemplary embodiment of the closed too slowly table, the duration for each listed task (i.e., the tasks named Task B) may be over 16 days while the OLA may only be listed as 7 days. Below the table are instructions directed to various task owners for avoiding and/or decreasing the time required to fulfill tasks. In some cases, the task may be completed beyond the OLA if the OLA does not properly reflect the true capabilities of the various task owners. For example, the task owner may be assigned a large number of tasks during certain periods such as when there is a power outage, during equipment upgrades, or during a new product launch. During periods of increased or decreased workloads, the OLA may be adjusted accordingly. As another example, equipment loss or malfunctions or decreases in team members may also be strain on task owner resources. In such cases, the OLA should be adjusted if known before the task is assigned, or the task work flow could be re-prioritized. If the lag in task duration is attributable to tool, process, training gaps, attention should be given to resolving such issues. For example, the failure to meet the OLA may be resolved by assigning team member to certain tasks according to their type of work experience, length of work experience, past performance, the difficulty of the task, and the like. If the assigned tasks in the service request or work flow is not optimal, the work flow may be re-arranged, tasks modified, task owners re-assigned, and the like.

Referring now to FIG. 14, the closed for others table and the closed by others table are illustrated. In the closed for other table, a sample list of tasks closed by the subject support team of the report for others, i.e., the target support team for each task. In some cases, closing tasks for other is unnecessary and may hamper the fulfilling team's ability to complete their own assigned work. In other cases, the tasks may have been incorrectly assigned. In still other cases, the fulfilling team may have extra resources or diminished workflow and may thus be temporarily assigned a new task if the other team is unwilling or unable to fulfill a task. Temporary assignments may avoid a situation where a task left unfulfilled by another team hampers a task owner in fulfilling their own task.

Further shown in FIG. 14, is the closed by others table, which includes a sample of tasks assigned to the subject team of the report (i.e., the targeted team or task owner assigned to the task). Instructions listed below the closed by others table indicate that the task owner should ensure that assigned tasks are fulfilled by the task owner. For example, the manager of the other team fulfilling tasks should be contacted and asked to stop or offered a schedule for taking over tasks fulfilled by the other team. Having others fulfill unassigned tasks can create duplicate efforts, wasted resources, and confusion. For example, the task owner may have been preparing or planning to fulfill the task closed by another team.

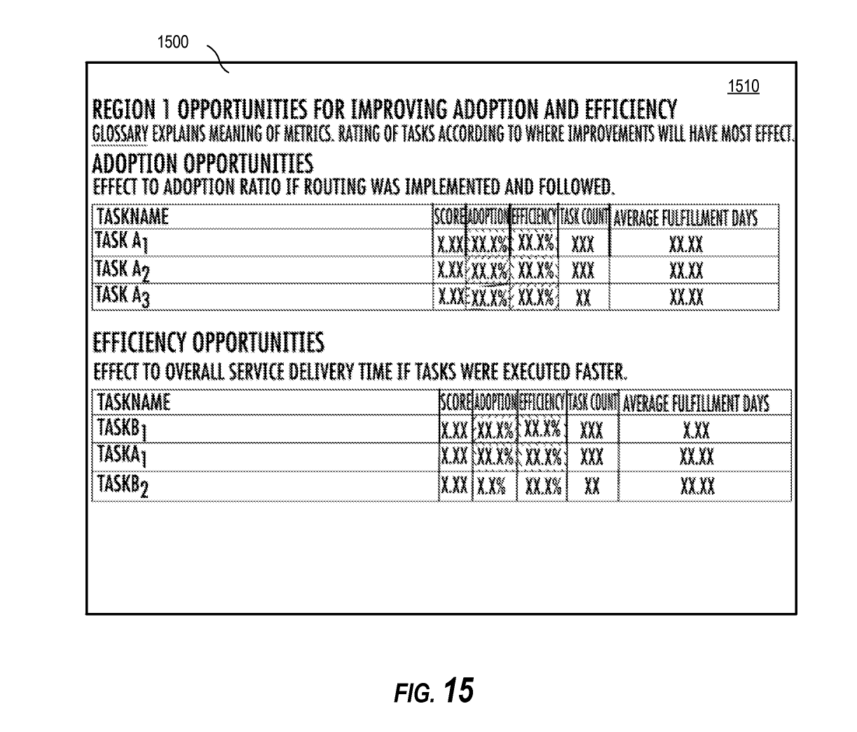

Referring now to FIG. 15, a GUI 1500 of a report 1510 illustrating adoption and efficiency opportunities is illustrated. In FIG. 15, an exemplary table of adoption opportunities is shown. The adoption opportunities table includes task names, task scores, task counts, and average fulfillment days for each task. The table lists the tasks that need more attention in order to improve adoption ratios. The tasks that need the most improvement are listed first in accordance with the task score (highest to lowest task score), which as explained above, takes adoption ratios into account. In FIG. 15, an efficiency opportunities table is illustrated. Like the adoption opportunities table, the efficiency opportunities table lists tasks that need the most attention in order to improve efficiency in accordance with the task score. The task score is used to rank the tasks because the tasks score takes into account all of the listed variables including efficiency. By reviewing the efficiency and adoption opportunity report, task owners and system operators can not only review task specific performance ratings, but can also use the report as an aid in determining why performance is poor or excellent and how to improve performance.

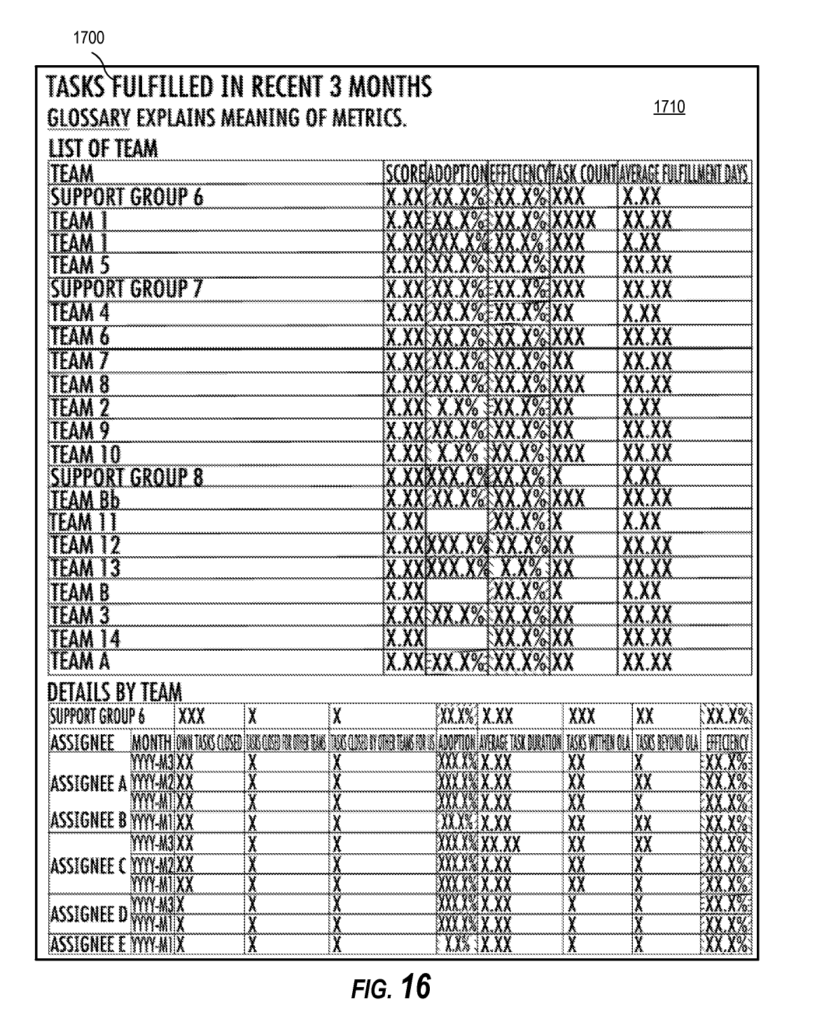

FIG. 16 includes a GUI 1600 of a report 1610 for tasks fulfilled in the most recent three previous months up to the current date of the report. The report 1610 includes a breakdown of various performance parameters by team and a more detailed analysis of the performance by the team. The list of teams includes teams from Region 1 as well as teams from other regions or sub-regions. The teams are listed by task score, where the teams with highest task score are ranked first. The details table focuses on Support Group 6 and lists all assignees or team members in the team, and performance parameters for each team member. For example, Assignees A and C completed multiple tasks during the previous three months while Assignee B completed tasks in only one of the three previous months. Assignee E failed to complete any tasks during the most recent three months resulting in a low adoption ratio.

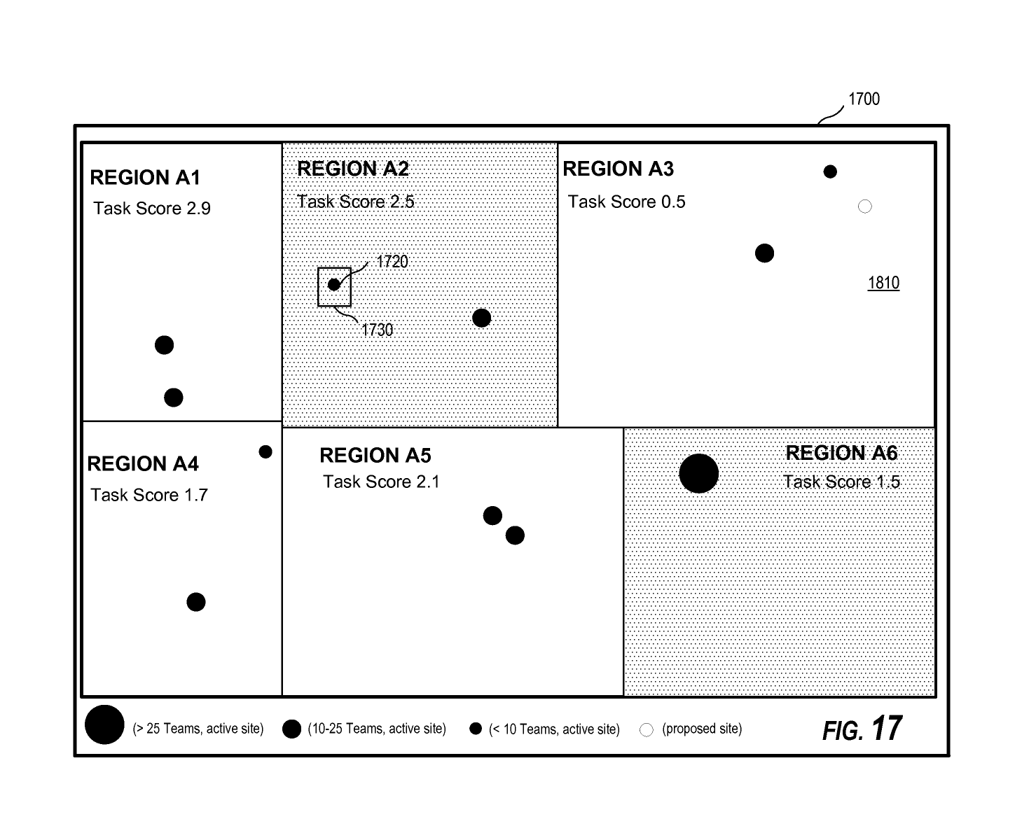

FIG. 17 is a GUI 1700 illustrating the configuration and assignment of various regions described herein. The GUI 1700 includes a grid 1710 containing six regions. The grid 1710 includes six rectangular enclosed areas corresponding to the six regions and indicating one 7 or more geographic areas defined by geographic coordinates, postal codes, city area, or any other geographic area. In the illustrated embodiment, the grid 1710 covers a local geographic area and not a global geographic area, but it will be understood that the geographic area in FIG. 17 may include a wider or narrower area. In additional or alternative embodiments, the regions A1-A6 are sub-regions of one of the regions of FIG. 7. Each of the regions A1-A6 includes at least one active or proposed working site, where each working site includes at least one support team. The support teams illustrated in FIG. 17 include task owners. Each rectangular enclosed area in the grid 1710 is labeled with a region and also includes task scores for each region for easy comparison. Other performance characteristics such as task count, efficiency, and other calculation may also be included in the grid 1710 for each region or for one or more working sites in each region.

As shown in FIG. 17, the grid 1710 indicates that the regions A1-A6 are divided by geographic area, working sites, and the number of teams. In some embodiments, the primary dividing parameter is the number of teams. For example, region A6 includes over 25 teams even though only 1 working site is located in region A6. As a given region increases in the number of teams or working sites, that region may be further divided into sub-regions. The minimum number of teams in a region may be set to 15 and the minimum number of working sites may be set to 1. The maximum number of teams in a region may be set to 50 and the maximum number of working sites may be set to 5. The system of GUI 1700 may require that each region in the grid 1710 include at least 15 teams and no greater than 5 proposed or active working sites and no greater than 50 teams and no less than 1 proposed or active working site. In other embodiments, secondary dividing parameters include geographic area, managers, task count, and the like. For example, the grid 1710 may be configured such that each working site in a given region is a certain distance from the lines dividing the regions or a certain minimum distance from another working site in an adjacent or bordering region.

In the illustrated, a user of GUI 1700 selects regions A2 and A6 to compare the regions in one or more detailed reports (e.g., the reports of FIGS. 7-16). A working site 1720 in region A2 is labeled with a box 1730 to indicate that the user is located at the working site 1720, a team member of working site 1720, or otherwise interested in the working site 1720. For example, a mobile device of the user that is in communication with the system of GUI 1700 may send geo-positioning data to the system to enable the system to locate and indicate the user's position on the grid 1710. The system of GUI 1700 allows a team member, manager, operator, researcher, or any other authorized party to easily view, compare, and assess the performance of other teams, regions, or sub-regions.

The flowcharts and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or teams thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to embodiments of the disclosure in the form disclosed. Many modifications and variations will be apparent to those of ordinary skill in the art without departing from the scope and spirit of embodiments of the disclosure. The embodiment was chosen and described in order to best explain the principles of embodiments of the disclosure and the practical application, and to enable others of ordinary skill in the art to understand embodiments of the disclosure for various embodiments with various modifications as are suited to the particular use contemplated. Although specific embodiments have been illustrated and described herein, those of ordinary skill in the art appreciate that any arrangement which is calculated to achieve the same purpose may be substituted for the specific embodiments shown and that embodiments of the disclosure have other applications in other environments. This application is intended to cover any adaptations or variations of the present disclosure. The following claims are in no way intended to limit the scope of embodiments of the disclosure to the specific embodiments described herein.

As noted above with regard to FIG. 3, the embodiments further include normalization of service request naming data elements. Exemplary code is listed below.

### Source Code Listing Submitted as Part of the Specification

```
# Fields for server provisioning service request
#
sub spfields {
  my %map = reverse (
    platform => ′SRM1.ServiceRequest.BuildInformation.Platform′,
    region => ′SRM1.ServiceRequest.FI.Region′,
    datacenter => ′SRM1.ServiceRequest.FI.DC Location′,
    cto => ′SRM1.ServiceRequest.PR.CTO′,
    requestid => ′SRM1.ServiceRequest.SR Request Number′,
    requester =>SRM1.ServiceRequest.SR Requester′,
    buildtype => ′SRM1.ServiceRequest.OS.Build Type′,
    osname => ′SRM1.ServiceRequest.OS.OS Name′,
    hostname => ′SRM1.ServiceRequest.SI.Logical Server/Host Name′,
    group => ′SRM1.TSK.Task.Assignee Group′,
    assignee => ′SRM1.TSK.Task.Assignee′,
    taskstart => ′SRM1.TSK.Task.Activate DateTime (GMT)′,
    taskend => ′SRM1.TSK.Task.Actual End DateTime (GMT)′,
    taskid => ′SRM1.TSK.Task.Task ID′,
    taskname => ′SRM1.TSK.Task.Task Name′,
    sequence => ′SRM1.TSK.Task.Sequence′,
    status => ′SRM1.TSK.Task.Status′,
    product => ′SRM1.SR.Infrabase.OS.Product Family Name′,
    category => ′SRM1.SR.ServiceRequest.Title SRD′,
  );
  \%map;
}
# Fields for equipment placement service request
#
sub epfields {
  my %map = reverse (
    platform => ′SRM1.SR.EP Line.Item.Material Type′,
    region => ′SRM1.SR.AIF.Equipment Placement.Region′,
    datacenter => ′SRM1.SR.AIF.Equipment Placement.Facility Name′,
    cto => ′SRM1.SR.AIF.Equipment Placement.CTO′,
    requestid =>SRM1.WO.WorkOrder.Service Request ID′,
    requester => ′SRM1.SR.AIF.Equipment Placement.Requester′,
    buildtype => ′SRM1.SR.EP Line Item.Material Name′,
    hostname => ′SRM1.SR.EP Line Item.Host Name′,
    group => ′SRM1.TSK.Task.Assignee Group′,
    assignee => ′SRM1.TSK.TaskAssignee′,
    taskstart => ′SRM1.TSK.Task.Activate DateTime (GMT)′,
    taskend => ′SRM1.TSK.Task.Actual End DateTime (GMT)′
    taskid => ′SRM1.TSK.Task.Task ID′,
    taskname => ′SRM1.TSK.Task.Task Name′
    sequence => ′SRM1.TSK .Task.Sequence′,
    status => ′SRM1.TSK.Task.Status′,
  );
  \%map;
}
# Fields for server decommissioning service request
#
sub decomfields {
  my %map = reverse (
    platform => ′SRM1.SR.DCOM .Engagement.Server.Server Type′,
    region => ′SRM1.SR.DCOM Engagement.WO.Region′,
    datacenter => ′SRM1.SR.DCOM Engagement.Server.Facility′,
    cto => ′SRM1.SR.DCOM Engagement.AIT.CTO′,
    requestid => ′SRM1.SR.DCOM Engagement.Service Request′,
    requester => ′SRM1.SR.DCOM Engagement.WO.Customer Full
    Name′,
    osname => ′SRM1.SR.DCOM Engagement.Server.Operating System′,
    hostname => ′SRM1.SR.DCOM Engagement.Server.Server Name′,
    group => ′SRM1.SR.DCOM Engagement WO.Request Assignee
  Support Group Name′,
    assignee => ′SRM1.SR.DCOM Engagement.WO.Work Order Assignee′,
    taskstart => ′SRM1.SR.DCOM Engagement.WO.Submit DateTime
    (GMT)′,
    taskend => ′SRM1.SR.DCOM.Engagement.WO.Completed DateTime
    (GMT)′,
    taskid => ′SRM1.SR.DCOM Engagement.WO.Work OrderID′,
    taskname => ′SRM1.SR.DCOM Engagement.WO.Summary′,
    status => ′SRM1.SR.DCOM Engagement.WO.Work Order Status′,
    msgproduct => ′SRM1.SR.DCOM Engagement.AMESR.
    Selected Product Type′,
    dbproduct => ′SRM1.SR.DCOM Engagement.DD.Selected Database
    Type′,
  );
  \%map;
}
# Fields for hardware install service request
#
sub hwfields {
  my %map =reverse (
    region => ′SRM1.WO.WorkOrder.Region′,
    datacenter => ′SRM1.WO.WorkOrder.Site′,
    cto => ′SRM1.WO.WorkOrder,CTO′,
    requestid => ′SRM1.WO.WorkOrder.Service Request ID′,
    requester =>SRM1.WO.WorkOrder.Customer Name′,
    group => ′SRM1.TSK.Task.Assignee Group′,
    assignee => ′SRM1.TSK.Task.Assignee′,
    taskstart => ′SRM1.TSK.Task.Activate DateTime (GMT)′,
    taskend => ′SRM1.TSK.Task.Actual End DateTime (GMT)′,
    taskid => ′SRM1.TSK.Task.Task ID′,
    taskname => SRM1.TSK.Task.Task Name′,
    sequence => ′SRM1.TSK.Task.Sequence′,
    status => ′SRMI.TSK.Task.Status′,
  );
  /%map;
}
# Fields for projects
#
sub prfields {
  my %map = reverse (
    platform => ′SRM1.ITBM.Project.Forecast Type′,
    region => ′SRM1.ITBM.Project.Region′,
    cto => ′SRM1.ITBM.Project.CTO′,
    requestid =>SRM1.ITBM.Project.Project ID′,
    requester => ′SRM1.ITBM.Project.Created By′,
    assignee => ′SRM1.ITBM.Project.Last Updated By′,
    taskstart => ′SRM1.ITBM.Project.Created DateTime (GMT)′,
    taskend => ′SRM1.ITBM.Project Task Activity.Response DateTime
    (GMT)′,
    taskid => ′SRM1.ITBM.Project Task Activity.ID′,
    taskname => ′SRM1.ITBM.Project Task Activity.Approval Task ′,
    status => ′SRM1.ITBM.Project Task Activity.Approval Status′,
  );
  \%map;
}
```

What is claimed is:

1. A system for tracking and analyzing services, the system comprising:
a computer apparatus including a processor and a memory; and
a service tracking software module stored in the memory, comprising executable instructions that when executed by the processor cause the processor to:
receive a service request comprising one or more tasks;
create a routing rule for each task;
identify a task owner for each task based on the routing rule;
receive an operational level agreement (OLA) from the task owner for each task, wherein the OLA comprises an estimated time period needed to complete the one or more tasks;
receive records of the one or more tasks upon completion of the tasks and extract task information from the records;
analyze the task information and OLA; and
provide at least one report comprising varying aggregated levels of analysis to a user.

2. The system of claim 1, wherein the executable instructions further cause the processor to:
identify one or more fulfillers of the one or more tasks;
determine whether the one or more fulfillers and the task owner of each task match.

3. The system of claim 2, wherein the executable instructions further cause the processor to:
aggregate the one or more fulfillers and task owner of each task;
calculate the number of tasks completed by a first fulfiller matched to the task owner;
calculate the number of tasks completed by a second fulfiller not matched to the task owner.

4. The system of claim 3, wherein the executable instructions further cause the processor to:
provide a report to the task owner comprising the number of tasks assigned and completed by the task owner, the number of tasks not assigned and completed by the task owner, and the number of tasks assigned and completed by another.

5. The system of claim 1, wherein the executable instructions further cause the processor to:
determine the duration of each of the one or more tasks;
compare the duration of each task and the OLA of each task;
determine whether the task was completed within the OLA or beyond the OLA.

6. The system of claim 5, wherein the executable instructions further cause the processor to:
determine that the duration of at least one task is less than the estimated time period of the OLA associated with the at least one task and greater than a predefined threshold;
determine that the at least one task is not compliant with the OLA based on the determination.

7. The system of claim 1, wherein the executable instructions further cause the processor to:
calculate an adoption ratio as the number of tasks assigned to the task owner and completed by the task owner versus the total number of tasks assigned to the task owner;
determine potential gains from improving adoption of the routing rules by the task owner based on the adoption ratio.

8. The system of claim 7, wherein the executable instructions further cause the processor to:
calculate the number of days it takes to complete a task starting on the day the task is assigned to the day the task is closed;
determine efficiency of the task owner in completing the one or more tasks, the efficiency being adversely correlated to the calculated number of days.

9. The system of claim 7, wherein the task information comprises routing data, fulfillment data, organizational data, and duration data

10. The system of claim 1, wherein the executable instructions further cause the processor to:
divide the at least one task into multiple portions; and
assign each portion of the at least one task to one or more task owners.

11. The system of claim 1, wherein the executable instructions further cause the processor to:
assign a workflow to the one or more tasks;
wherein a first set of tasks is configured to occur in chronological order and a second set of tasks is configured to occur in parallel based on the workflow.

12. A computer program product for tracking and analyzing services, the computer program product comprising:
a non-transitory computer readable storage medium having computer readable program code embodied therewith, the computer readable program code comprising:
computer readable program code configured to receive a service request comprising one or more tasks;
computer readable program code configured to create a routing rule for each task;
computer readable program code configured to identify a task owner for each task based on the routing rule;
computer readable program code configured to receive an operational level agreement (OLA) from the task owner for each task, wherein the OLA comprises an estimated time period needed to complete the one or more tasks;
computer readable program code configured to receive records of the one or more tasks upon completion of the tasks and extract task information from the records;
computer readable program code configured to analyze the task information and OLA; and
computer readable program code configured to provide at least one report comprising varying aggregated levels of analysis to a user.

13. The computer program product of claim 12, further comprising computer readable program code configured to identify one or more fulfillers of the one or more tasks and determine whether the one or more fulfillers and the task owner of each task match.

14. The computer program product of claim 13, further comprising computer readable program code configured to aggregate the one or more fulfillers and task owner of each task;
calculate the number of tasks completed by a first fulfiller matched to the task owner; and
calculate the number of tasks completed by a second fulfiller not matched to the task owner.

15. The computer program product of claim 12, further comprising computer readable program code configured to calculate an adoption ratio as the number of tasks assigned to the task owner and completed by the task owner versus the total number of tasks assigned to the task owner and determine potential gains from improving adoption of the routing rules by the task owner based on the adoption ratio.

16. The computer program product of claim 12, further comprising computer readable program code configured to calculate the number of days it takes to complete a task starting on the day the task is assigned to the day the task is closed and determine efficiency of the task owner in completing the one or more tasks, the efficiency being adversely correlated to the calculated number of days.

17. A computer-implemented method for tracking and analyzing services, the method comprising:
receiving a service request comprising one or more tasks;
creating, by a processor, a routing rule for each task;
identifying, by a processor, a task owner for each task based on the routing rule;
receiving an operational level agreement (OLA) from the task owner for each task, wherein the OLA comprises an estimated time period needed to complete the one or more tasks;
receiving records of the one or more tasks upon completion of the tasks and extract task information from the records;
analyzing, by a processor, the task information and OLA; and
providing, by a processor, at least one report comprising varying aggregated levels of analysis to a user.

18. The computer-implemented method of claim 17, further comprising:
determining, by a processor, the duration of each of the one or more tasks;
comparing, by a processor, the duration of each task and the OLA of each task; and
determining, by a processor, whether the task was completed within the OLA or beyond the OLA.

19. The computer-implemented method of claim 17, further comprising:
calculating, by a processor, an adoption ratio as the number of tasks assigned to the task owner and completed by the task owner versus the total number of tasks assigned to the task owner; and
determining, by a processor, potential gains from improving adoption of the routing rules by the task owner based on the adoption ratio.

20. The computer-implemented method of claim 17, further comprising:
calculating, by a processor, the number of days it takes to complete a task starting on the day the task is assigned to the day the task is closed; and
determining, by a processor, efficiency of the task owner in completing the one or more tasks, the efficiency being adversely correlated to the calculated number of days.
